(19) United States
(12) Patent Application Publication
(10) Pub. No.: US 2007/0242413 A1
(43) Pub. Date: Oct. 18, 2007

(54) Power Capacitor

(75) Inventors: Birger Drugge, Vasteras (SE); Johan Mood, Ludvika (SE); Kenneth Dowling, Bro (SE); Sari Laihonen, Vasteras (SE); Carl-Olof Olsson, Vasteras (SE); Tommy Holmgren, Ludvika (SE)

Correspondence Address: VENABLE LLP, P.O. BOX 34385, WASHINGTON, DC, 20043-9998, US

(73) Assignee: ABB Technology Ltd, Zurich (CH)

(21) Appl. No.: 10/583,386

(22) PCT Filed: Dec. 17, 2004
(86) PCT No.: PCT/SE04/01923

§ 371 Date: Jun. 18, 2007

(30) Foreign Application Priority Data
Dec. 19, 2003 (SE) 0303482-4

(51) Int. Cl. H01G 4/224

(52) U.S. Cl. 361/301.3

(57) ABSTRACT

A power capacitor including at least one capacitor element enclosed in a container, wherein the container is of a material which substantially includes a first polymer material. Further, the container is cylindrical and provided in its surface with creepage distance extending protrusions of a second polymer material. The protrusions are formed with respect to their thickness and radial length so as to cool the capacitor. In a method for manufacturing such a power capacitor, a substantially cylindrical container is made of a material which substantially includes a first polymer material. The container is provided on its envelope surface with creepage distance-extending protrusions of a second polymer material and the capacitor elements are encapsulated in the container.

### TECHNICAL FIELD

The present invention relates, from a first aspect, to a power capacitor of the kind that comprises at least one capacitor element enclosed in a container and surrounded by at least one insulating medium. From a second aspect, the invention also relates to a method for manufacturing such a capacitor.

The power capacitor according to the invention is primarily intended for a rated voltage that exceeds 1 kV, for example 5 kV, preferably at least 10 kV.

### BACKGROUND ART

Power capacitors are important components in systems for transmission and distribution of electric power for both alternating current and direct current. Power capacitor installations are mainly used for increasing the power-transmission capacity through parallel and series compensation, for voltage stabilization through static var systems and as filters for eliminating harmonics.

Capacitors have a phase angle that is close to 90° and therefore generate reactive power. By connecting capacitors in the vicinity of the components that consume reactive power, the desired reactive power may be generated there. Wires and cables may thus be fully utilized for transmission of active power. The consumption of reactive power of the load may vary and it is desirable to generate all the time a quantity of reactive power corresponding to the consumption. For this purpose, a plurality of capacitors are interconnected via series and/or parallel connection in a capacitor bank. A necessary number of capacitors may be connected, corresponding to consumed reactive power. Compensating for consumed power by utilizing capacitors in the manner mentioned above is referred to as phase compensation. A capacitor bank in the form of a so-called shunt battery is arranged for this purpose in the vicinity of the components that consume reactive power. Such a shunt battery consists of a plurality of interconnected capacitors. The individual capacitor in turn comprises a plurality of capacitor elements. The construction of such a conventional capacitor will be explained below.

A shunt battery usually comprises a number of chains of a plurality of series-connected capacitors. The number of chains is determined by the number of phases, which usually is three. The first one of the capacitors in a chain is connected to a line for transmission of electric power to the consuming component. The line for transmission of electric power is arranged at a certain distance from the ground or from points in the surroundings which electrically are at ground potential. This distance is dependent on the voltage of the line. The capacitors are connected in series from the first capacitor, which is connected to the line, and downwards. A second capacitor, which is arranged at an end of the chain of series-connected capacitors opposite to the end of the first capacitor, is connected to ground potential or to a point in the electric system that has zero potential, for example non-grounded three-phase systems. The number of capacitors and the design thereof are determined such that the permissible voltage, also called the rated voltage, across the series-connected capacitors corresponds to the voltage of the line. A plurality of capacitors are connected in series and arranged in stands or on platforms that are insulated from ground potential. Such a capacitor bank thus comprises a plurality of different components and is relatively material-demanding. Further, a relatively robust structure is required for the stand/the platform to withstand external influence in the form of wind, earthquake, etc. Thus, extensive work is required for constructing such a capacitor bank.

Long lines for alternating voltage are inductive and consume reactive power. Capacitor banks for so-called series compensation are therefore arranged in spaced relationship along such a line for generating the required reactive power. A plurality of capacitors are connected in series for compensation of the inductive voltage drop. At a capacitor bank for series compensation, the series connection of capacitors, contrary to a shunt battery, usually only absorbs part of the voltage of the line. Further, the chains of series-connected capacitors, included in the capacitor bank for series compensation, are arranged in series with the line that is to be compensated.

A conventional capacitor bank comprises a plurality of capacitors. Such a capacitor comprises in turn a plurality of capacitor elements in the form of capacitor rolls. The capacitor rolls are flattened and stacked on top of each other, forming a stack of, for example, 1 m. A very large number of dielectric films with intermediate metal layers will be arranged in parallel in the vertical direction of the stack. When a voltage applied across the stack increases, the stack will be compressed somewhat in the vertical direction due to Coulomb forces acting between the metal layers. When lowering the voltage, the stack will expand somewhat vertically for the same reason. The formed stack has a definite mechanical resonant frequency, or natural frequency, which is relatively low. The mechanical resonant frequency of the stack is amplified by specific frequencies of the current, which may result in a strong noise. Such a frequency is the mains frequency, which is defined by the fundamental tone of the current and is usually 50 Hz. Amplification of the mechanical resonant frequency may, however, also be achieved by harmonics of the current.

Examples of a power capacitor of this known kind are described in U.S. Pat. No. 5,475,272. This document thus describes a high-voltage capacitor built up of a plurality of capacitor elements stacked on top of each other and placed in a common container. The container is conventionally made of metal. Its electric bushings are made of porcelain or polymer. The document describes different alternative connections for connecting the capacitor elements in series or in parallel.

One disadvantage of a capacitor of a known type, for example of the kind described in the above-mentioned U.S. Pat. No. 5,475,272, is that the capacitor elements included therein must be insulated from the container. The insulation must withstand voltage stresses considerably higher than the rated voltage of the capacitor. It is desired to fill the capacitor volume as efficiently as possible with capacitor elements. Their external, flattened shape is unfavourable with respect to electric field reinforcement due to projecting foils, small radii, etc. They must also be interconnected via internal patch cables in a manner that often creates further local irregularities in the electric field plot. This leads to considerable requirements for electrical strength as far as the insulation against the container is concerned.

In capacitors of a known type, for example according to U.S. Pat. No. 5,475,272, the capacitor elements are impregnated with oil. The oil is also arranged to surround the capacitor elements and to fill up the space between these and the wall of the container. The oil is satisfactory from the point of view of insulation, but also entails certain disadvantages. Damage to the container or insufficient sealing may lead to oil leaking out, which may damage the function of the capacitor and, in addition, contaminate the surroundings.

A further disadvantage of a conventional power capacitor is the sound generation that arises. The sound generation is strongest when the vibrations that are generated by the electric voltage stress coincide with the mechanical resonant frequency of the capacitor. The resonant frequency is proportional to the square root of the quotient between the stiffness of the capacitor package perpendicular to the electrode layers and inversely proportional to the extent of the package perpendicular to the electrode layers.

The object of the present invention is to achieve a power capacitor which eliminates the disadvantages described above and which, from the point of view of electrical safety, may be used in the open.

### SUMMARY OF THE INVENTION

According to the first aspect of the invention, the above object has been achieved in that a power capacitor for high voltage of the kind described in the preamble to claim 1 comprises the special features that the container is substantially cylindrical and comprises, on its envelope surface, a plurality of creepage distance-extending protrusions of substantially a second polymer material and that the container is of a material which substantially comprises a first polymer material. The protrusions are shaped with regard to their thickness and radial length so that they also cool the capacitor.

Since the container is of a material that comprises a first polymer material, the need of insulation between the capacitor elements and the container is reduced. This also eliminates the risk of breakdown between the capacitor elements and the container. Further, the electrical connections of the capacitor may be made very simple and the necessary creepage distance between these may partly be obtained by the container itself. With the reduction of the need of insulation and because the electric bushings may be simplified, the capacitor will be relatively compact, thus offering a possibility of designing compact capacitor banks.

The choice of materials for the container causes the container to become resilient to a certain extent; it exhibits little sensitivity to cracking and combines good insulation property with other desired properties such as strength, handling ability, and cost.

Because of the cylindrical shape of the container, the advantage may be achieved that it closely surrounds the capacitor elements such that a compact capacitor is obtained, which, in addition, will have a shape which is advantageous from the point of view of manufacturing technique and which is electrically favourable.

The creepage distance-extending protrusions of non-conducting material result in a sufficient creepage distance also in case of outdoor use in rain and moisture. With a suitable design of the protrusions, also sufficient cooling of the capacitor will be achieved. Common designations of the protrusions are also sheds and flanges, respectively. The designation sheds is usually used when the primary purpose of the protrusions is to extend the creepage distance and the designation flanges is usually used when the primary purpose of the protrusions is to cool a device. With a suitable design, the protrusions function both as creepage distance extenders and as cooling flanges.

According to one embodiment of the invention, the capacitor elements are contained in at least one insulating medium which is in a state different from a liquid state within the working temperature interval of the capacitor.

By replacing the oil which is normally used as insulating medium in this way, the risk of the occurrence of oil leakage in the event of damage to the container is eliminated since no free floating oil is present.

According to an alternative design of the immediately preceding embodiment, the insulating medium, the container, and the protrusions of the container are all for the most part of a thermoset, based on, for example, epoxy, polyester or polyurethane.

According to another design of the above-mentioned embodiment, the insulating medium, the container and the protrusions of the container are for the most part of rubber, preferably silicone rubber.

Silicone rubber is a material which is well suited for all the tasks that the above-mentioned components are to fulfil and opens up possibilities of an advantageous manufacturing process.

In the embodiments described above, an alternative is that the mentioned components are of the same kind as polymer material, based on, for example, epoxy, polyester, polyurethane, or silicon rubber. For example, these components are made in one single piece. Such a capacitor is very favourable from the point of view of manufacturing technique and results in a robust and durable capacitor.

According to one embodiment of the invention, the container and the protrusions of the container are of different polymer materials. The advantage of this design is that each material may be optimized for the function of each respective component. By using for the container a polymer material different from that in the protrusions, the required strength properties may be imparted to the container whereas, in this respect, lower requirements are made on the material in the protrusions. One example of an appropriate material for the container is polyethylene and for the protrusions silicone rubber or EPDM (ethylene-propylene rubber). This combination of materials thus constitutes another example of an embodiment of the invented power capacitor.

According to one embodiment of the invention, the container is of fibre-reinforced thermoset and the protrusions of silicone rubber or EPDM (ethylene-propylene rubber).

According to one embodiment of the invention, the insulating medium is silicon in gel state. An insulating medium of this kind may be applied in a simple manner in liquid state and be brought to gel so that said leakage safety is achieved.

According to one embodiment of the invention, the insulating medium is a thermoset, based on, for example, epoxy, polyurethane, or polyester.

According to one embodiment of the invention, essentially the whole envelope surface of the power capacitor is covered with small protrusions with a thickness in the interval of 0.2-10 mm, preferably 1-4 mm and a radial length in the interval of 5-50 mm, preferably 10-25 mm. By arranging a plurality of small protrusions, an increased surface for air cooling is achieved on the outside of the capacitor as well as a delay of solar heating, which ensures that the capacitor will not be overheated.

According to another embodiment of the invention, a plurality of smaller protrusions are arranged between at least two larger protrusions. The smaller protrusions according to this embodiment have a thickness in the interval of 0.2-10 mm and a radial length in the interval of 5-30 mm. The larger protrusions, according to this embodiment, have a thickness in the interval of 2-10 mm and a radial length of the protrusions in the interval of 20-60 mm. A pattern of a plurality of smaller protrusions and at lest one larger protrusion is repeated along essentially the whole length of the capacitor. The smaller protrusions are substantially formed for maximum cooling but also extend the creepage distance along the container, whereas the larger protrusions are substantially formed to yield improved breakdown performance. For example, between 10 and 30, preferably between 10 and 20, smaller protrusions are arranged close to at least one larger protrusion.

According to one embodiment of the invention, at least two of the protrusions are arranged with an axial pitch (a2) in the interval of 5-25 mm.

According to one embodiment of the invention, the capacitor comprises a tubular element running in the direction of the cylinder and extending through all the capacitor elements in the container. With the aid of such a tubular element, the mechanical strength and stability of the capacitor is ensured. According to a preferred embodiment, the tubular element is reinforced; alternatively, a separate tube is arranged adjacent to the tubular element as additional reinforcement.

According to yet another embodiment of the invention, the container is reinforced to ensure the mechanical strength and stability of the capacitor.

According to a second aspect, the object of the invention has been achieved in that a method of the kind described in the preamble to claim 25 comprises the special features that a substantially cylindrical container is made of a material which substantially comprises a first polymer material and is provided on its envelope surface with creepage distance-extending protrusions of a second polymer material and the capacitor elements are encapsulated in the container. The protrusions are formed with regard to their thickness and radial length so that they also cool the capacitor.

By using said material for the container of the capacitor during manufacture and applying protrusions in the manner described, a power capacitor of the kind described in claim 1 may be achieved, which exhibits the advantages described above with reference to the description of the invented capacitor.

According to one embodiment of the invented method, the manufacture of the container, the application of the protrusions, and the encapsulation of the capacitor elements in an insulating medium take place by injection moulding. The injection moulding entails a rational manufacturing process in which a capacitor of the kind described above and possessing the advantages of such a capacitor may be achieved in a simple and cost-effective manner.

According to one embodiment of the invented method when applying injection moulding, this is performed in one single step and with one single material. This means that the possibility of a rational manufacturing process is utilized in an optimal way.

According to an alternative embodiment of the invented method when applying injection moulding, this is performed in two steps. In the first step, the capacitor elements are enclosed in the insulating medium. In the second step, the manufacture of the container, as well as the application of the protrusions, occurs. In the first step, a polymer material is used which has lower viscosity than the material used in the second step. In this embodiment, the materials for the different components are adapted to the respective functions these are to fulfil.

In a further example of an embodiment of the invented method, the capacitor elements are initially applied to a tubular element that extends through all the capacitor elements. In this way, a mechanical support for the capacitor elements is achieved.

In still another embodiment of the invented method, a cylindrical polymer tube is provided for forming the container, the protrusions are applied to the polymer tube, and the capacitor elements are placed in the container which is filled with an insulating medium. In such a method, the material for the container may be optimized for its purpose and the material in the protrusions need not be limited to the corresponding material.

According to one embodiment of the invention, the tubular element is reinforced; alternatively, a separate tube is applied close to the tubular element as reinforcement. According to yet another embodiment, the container is reinforced.

The protrusions are applied, for example, according to any of the methods injection moulding, by winding them in a coil around the polymer tube, or by providing them as prefabricated, sleeve-like elements that are threaded onto the tube. Each of these methods has advantages from various aspects and where the current manufacturing conditions may be decisive for what is most appropriate.

According to one embodiment of the invention, the polymer tube is coated with RTV (Room Temperature Vulcanization) silicone or LSR (Liquid Silicone Rubber) before applying the protrusions. This facilitates the adhesion between the protrusions and the polymer tube and makes it possible to make the protrusions of a rubber material, such as silicone rubber. The coating also serves as protection for the polymer tube when the protrusions are not applied along the whole polymer tube.

In an additional embodiment of the invention, the protrusions are applied to the polymer tube by injection moulding and the polymer tube is surface-treated prior to the injection moulding. As in the immediately preceding embodiment, this facilitates the adhesion when the protrusions are of rubber. The surface treatment comprises, for example, washing the surface with a solvent, then surface-treating it, and then coating it with a primer, all of these measures creating good conditions for the adhesion.

According to a further embodiment of the invention, a mechanical support for the polymer tube is applied prior to the injection moulding. In this way, the risk of the polymer tube being deformed during the injection moulding can be eliminated.

The invention also relates to use of a power capacitor according to any of claims 1-24 at voltages exceeding 1 kV, preferably at least 5 kV. In addition, the invention also relates to use of a power capacitor according to any of claims 1-24 in a system for transmission of alternating current (ac).

The invention will be explained in greater detail by the subsequent description of embodiment thereof with reference to the accompanying drawings.

### BRIEF DESCRIPTION OF THE DRAWINGS

FIG. 1 is a schematic perspective view of a capacitor of the kind to which the present invention is suitable to apply,

FIG. 2 shows a detail of FIG. 1,

FIG. 3 is a graph illustrating the development of heat in a capacitor element in a capacitor according to FIG. 1,

FIG. 4 is an enlarged radial partial section through the detail of FIG. 2,

FIG. 4a is a section corresponding to FIG. 4, but illustrating an alternative embodiment,

FIG. 4b is a section corresponding to FIG. 4, but illustrating a further alternative embodiment,

FIG. 5 is a longitudinal section through a capacitor element according to an alternative embodiment,

FIG. 6 shows two interconnected capacitor elements according to FIG. 5,

FIG. 7 is a longitudinal section through a capacitor according to the invention and illustrates an embodiment of its design,

FIG. 8 is a longitudinal section through a capacitor according to the invention and illustrates an alternative embodiment of its design,

FIG. 9 is a longitudinal section through a capacitor according to the invention and illustrates another embodiment of its design,

FIG. 10 is a longitudinal section through a capacitor and illustrates a further embodiment of its design,

FIG. 11 is a longitudinal section through a capacitor according to yet another embodiment.

### DESCRIPTION OF PREFERRED EMBODIMENTS OF THE INVENTION

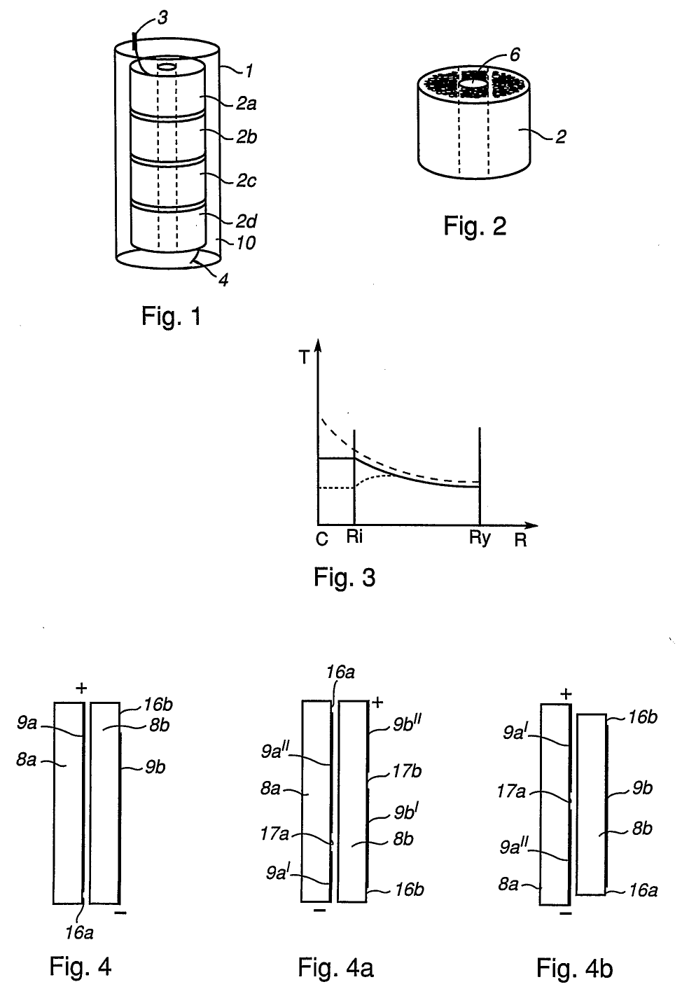

FIG. 1 shows the fundamental design of a capacitor according to the invention. It comprises an outer container 1 of polyethylene, in this case surrounding four capacitor elements 2a-2d. The container 1, as well as the capacitor elements 2a-2d, is circularly cylindrical. The capacitor elements 2a-2d are connected in series. At each end of the capacitor, a connection terminal 3, 4 is arranged. Each terminal consists of a conductive foil which is attached to the material of the container and extends therethrough. Between the capacitor elements 2a-2d and the container, a gel 10 is arranged. The gel serves as electrical insulation and as a thermal conductor.

FIG. 2 shows an individual capacitor element. This consists of metal-coated polymer films tightly rolled in a roll. The capacitor element 2 has a central axial through-hole 6 that may be used for cooling of the element. Typical dimensions of such a capacitor element is a diameter of 20-400 mm, preferably 150-250 mm, a bore diameter of 10-250 mm, preferably at least 50 mm and a height of 50-800 mm, preferably 125-200. Such a capacitor element is intended for a voltage of about 1-100 kV. A capacitor element with a diameter of, for example, 180 mm, a bore diameter of 60 mm and a height of 150 mm is intended for a voltage of about 1-20 kV. Thus, with four such elements connected in series, as in FIG. 1, a voltage of up to 80 kV is obtained. With eight, 160 kV is obtained, etc.

Heat losses arise in the capacitor element 2, resulting in internal heating of the element. The maximum temperature is critical for the dimensioning of the capacitor element. FIG. 3 shows the temperature T in relation to the radius R, where C is the centre of the capacitor element. In a cylindrical volume with a homogeneous heat generation, and without any opening in the centre, the temperature profile in a radial direction will have an appearance according to the dashed-lined curve in FIG. 3. If the capacitor element is formed with an opening in the centre 6 with the radius Ri, the temperature profile will be according to the unbroken curve in FIG. 3. Further, cooling is made possible, where necessary, The temperature profile obtained will then be according to the dotted curve in FIG. 3. Suitable choices of Ri, the outer radius Ry, and the electric power, and thus the losses, contribute to controlling the maximum temperature in the capacitor element. The centre opening 6 in each capacitor element 2 may also be utilized for centering of the capacitor elements. To this end, the capacitor elements are threaded onto a centering tube that extends through all the capacitor elements.

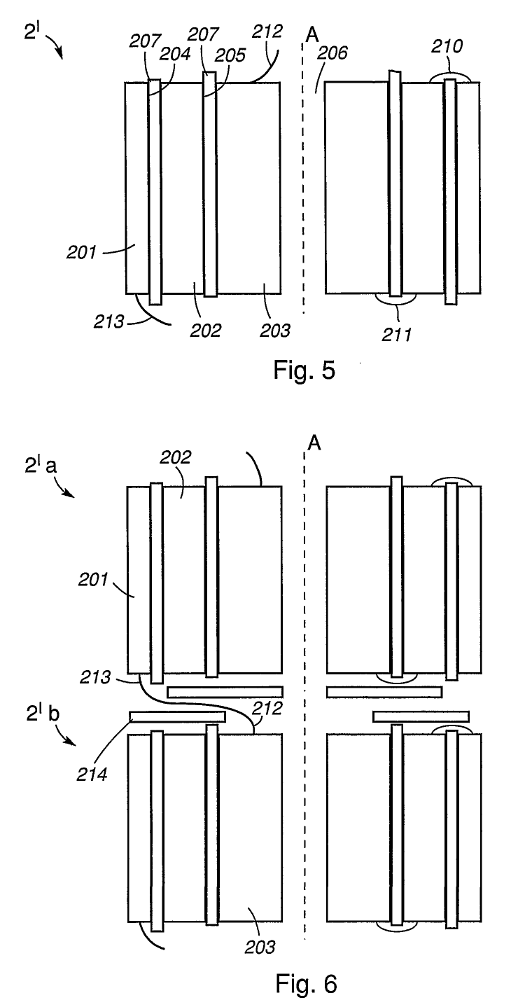

FIG. 4 shows an enlarged radial partial section through a capacitor element in FIG. 2. The partial section shows two adjacently located turns of the metal-coated film. The films 8a and 8b, respectively, have a thickness of 10 μm and the material is polypropylene. The metal layer 9a, 9b have a thickness of about 10 nm and consist of aluminium or zinc or a mixture thereof, which prior to rolling has been applied to the polypropylene film by vapour deposition. The technique of manufacturing a capacitor element in this way is already known per se, and therefore a more detailed description is superfluous. Alternatively, the capacitor elements may be composed using film-foil technique, wherein propylene film and aluminium foil are rolled together. However, using metallized film has the advantage of being self-healing and permits higher electrical stress and higher energy density than using the film-foil technique. The metal layer covers the plastic film from one of its side edges up to a short distance from its other side edge. A border region 16a of the film 8a is thus without metal coating. Correspondingly, a border region 16b of the film 8b is without metal coating. The free border region 16b of the film 8b is, however, at the opposite end edge compared to that of the film 8a. An electrical connection for the layer 9a is obtained in the figure as viewed at the upper end of the element and at the lower end for the layer 9b, so that in one direction there will be a positive electrode and in the other direction there will be a negative electrode. For efficient electrical contact, the end portions may be metal-sprayed, for example with zinc.

In the modified embodiment according to FIG. 4a, the capacitor element is made with a so-called inner series connection. Here, the metal layer 9a, 9b on each plastic film 8a, 8b divided into two portions 9a′, 9a″, and 9b′, 9b″, respectively, separated by a non-coated part 17a and 17b, respectively. It is also possible to divide the metal layers into more portions than two. Each pair of metal-layer portions, for example 9a′ and 9b′, forms a sub-capacitor element, which are series-connected.

FIG. 4b shows a variant of the modified embodiment according to FIG. 4a where the metal layer 9a on one plastic layer 8a only is divided into two portions 9a′, 9a″, separated by a non-coated part 17a whereas the metal layer 9b on the other plastic film 8b is undivided. Each of the portions 9a′ and 9a″ extends all the way up to the edge of the film 8a so that the electrical connection in this case takes place to one and the same film 8a. The metal layer 9b on the other plastic film terminates on both sides a distance 16a, 16b away from the edge of the film and is thus not electrically connected in any direction.

FIG. 5 shows in a longitudinal section an alternative embodiment of a capacitor element 2′ according to the invention. The capacitor element is divided into three subelement 201, 202, 203 which are concentric with the common axis designated A. The outermost subelement 201 is almost tubular with an inner side 204 which, with a small distance, surrounds the central subelement 202. In a similar way, the central subelement has an inner side 205 which closely surrounds the innermost subelement 203. The innermost subelement 203 has a central through-channel 206. The three subelements have different radial thicknesses, the outermost element having the smallest thickness. In this way, they have substantially the same capacitance. Between the subelements, insulation 207 is arranged.

The subelements are connected in series. Two radially adjoining subelements have one of their respective connection points at the same end. Thus, the outermost subelement 201 is connected, by means of connection member 210, to the central subelement 202 at one end of the capacitor element 2′, and the central subelement 202 is connected, by means of connection member 211, to the innermost subelement 203 at the other end of the capacitor element 2′. In this way, the connections 212, 213 for the capacitor element 2′ will be located at a respective end thereof.

If the number of subelements is greater than three, for example five or seven, the procedure of alternately connecting together the connection points at the ends of the subelements will continue in the same way.

FIG. 6 illustrates how a plurality of capacitor elements of the kind shown in FIG. 5 are connected in series. The figure shows two such capacitor elements 2′a, 2′b. The connection 212 of the lower capacitor element 2′b to the upper end of the inner subelement 203 is connected to the connection of the upper capacitor element 2′a to the lower end of the outer subelement 201. Between the capacitor elements, insulation 214 is arranged to withstand the potential differences that arise with this kind of capacitor element.

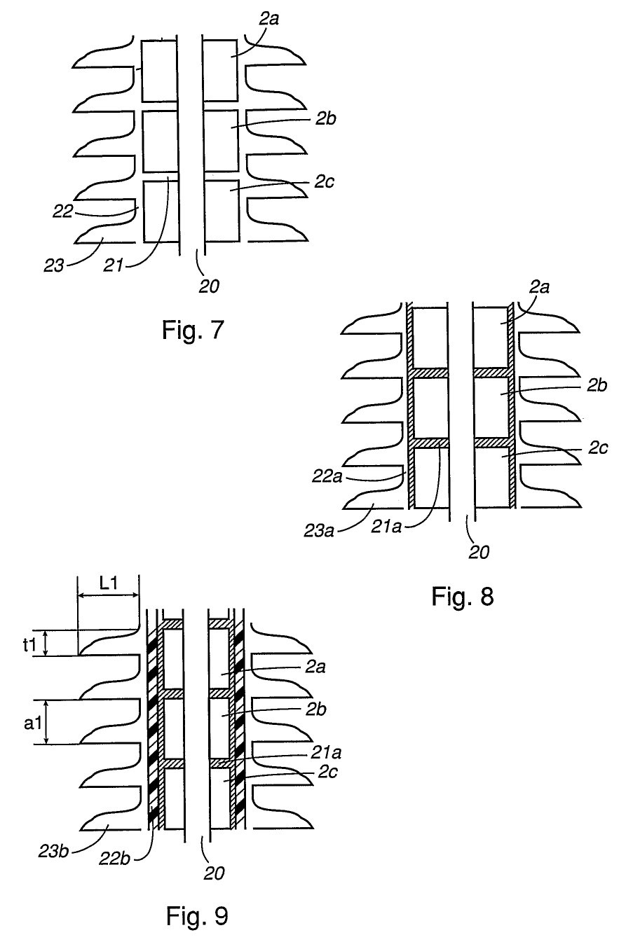

FIG. 7 is a section through a power capacitor according to one embodiment of the invention. The capacitor is built up of a number of cylindrical capacitor elements 2a, 2b, 2c of the kind described in more detail with reference to FIGS. 1-6. The capacitor elements 2a, 2b, 2c are coaxially threaded onto a cylindrical tube 20 of an insulating material with sufficient strength properties to support the weight of the power capacitor with no risk of vibrations. The cylindrical tube 20 may be mechanically reinforced, for example by armouring; alternatively, the cylindrical tube 20 is supplemented by a separate tube (not shown). The cylindrical tube may be solid or hollow. The capacitor elements 2a, 2b, 2c are enclosed in a cylindrical container 22. The container contains an insulating medium 21 that surrounds the capacitor elements 2a, 2b, 2c. On the outside of the container 22, a number of creepage distance-extending protrusions 23 are arranged in the form of circular sheds.

The insulating medium 21, the container 22 and the protrusions 23 are of one and the same material and forms one single piece. The material is a polymer material, based on, for example, epoxy, polyurethane, polyester or rubber, preferably silicone rubber.

The manufacture of the container 22, the insulating medium 21 and the protrusions 23 is performed by injection moulding. Before the injection moulding, the capacitor elements 2a, 2b, 2c are arranged on the central tube 20 in predetermined spaced relationship to one another. Then, the injection moulding occurs in one single stroke where both the insulating medium 21 and the container 22 and its protrusions 23 are formed. In connection with the injection moulding, the capacitor may be provided with end closures (not shown) through which the electrical connection is drawn.

FIG. 8 is a section corresponding to FIG. 7 through an alternative embodiment. One difference between the embodiments according to FIG. 7 and FIG. 8 is that in the embodiment according to FIG. 8, the insulating medium 21a is of a material different from that of the container 22a and its protrusions 23. In this embodiment, the insulating medium 21a is of a first polymer quality. The polymer material in the insulating medium 21a has lower viscosity than that in the container 22a and the protrusions 23a.

Also in the embodiment according to FIG. 8, the container 22a, the insulating medium 21a and the protrusions 23 are made by injection moulding. However, in this case the injection moulding is made in two steps. In the first step, the insulating medium 21a is injection-moulded in between the capacitor elements 2a, 2b, 2c, after the capacitor elements having first been mounted on the tube 20. In the second step, the container 22a and the protrusions 23a are injection-moulded on the unit obtained after the first step.

During the manufacture according to the methods described with reference to FIGS. 7 and 8, it may be advantageous to take measures that protect the capacitor elements 2a, 2b, 2c and other components (not shown) in the capacitor, such as resistances and connections, from being damaged by the pressure applied during the injection moulding.

The capacitor elements 2a, 2b, 2c may advantageously also be provided with protection that prevents oxygen and water vapour from penetrating between them. This is because certain polymer materials have relatively great permeability to gases. The capacitor elements 2a, 2b, 2c may also be pretreated to achieve good adhesion of polymer material, such as silicone rubber, thereto.

FIG. 9 is a section through a power capacitor according to still another embodiment. The container 22b consists of a cylindrical polymer tube, suitably of polyethylene. On the container, a number of protrusions 23b are arranged. These are suitably of silicone rubber or EPDM. According to this embodiment, the container 22b of polyethylene is extruded and the protrusions 23b are applied to the polyethylene tube by injection moulding directly on the tube. To fulfil the necessary strength requirements, the container 22b may be reinforced, for example by armouring.

According to another alternative embodiment of the immediately preceding embodiment, the container 22b is of fibre-reinforced thermoset and the protrusions 23b of silicone rubber or EPDM.

According to yet another alternative embodiment, the protrusions 23b are applied to the polymer tube by being wound on the tube in a spiral or, like prefabricated sleeve-like elements, being drawn onto the tube. The capacitor elements 2a, 2b, 2c are placed on the tube 20 in the container 22b and the container is filled with an insulating medium 21b, suitably silicone.

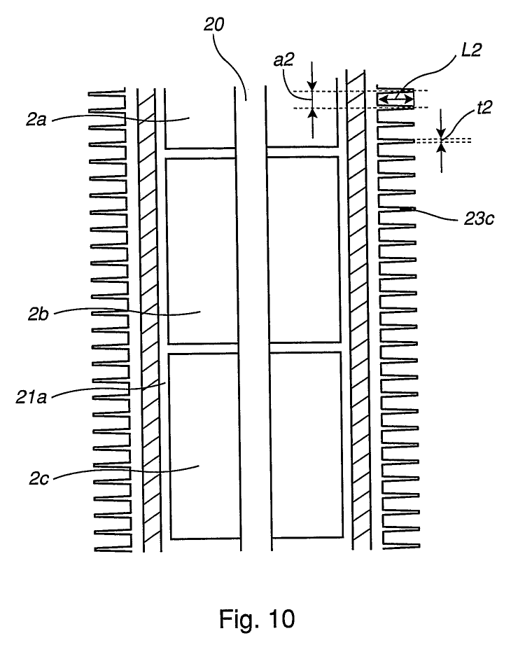

FIG. 10 is a longitudinal section through a power capacitor according to yet another embodiment. A protrusions 23c according to FIG. 10 has a thickness t2 in the interval of 0.2-10 mm, preferably 1-4 mm, a radial length L2 in the interval of 5-50 mm, preferably 10-25 mm, and an axial pitch a2 which is 5-25 mm. The protrusions are suitably of silicone rubber or EPDM and are arranged on a polymer tube, suitably of polyethylene. The protrusions function as creepage distance-extenders and, where necessary, also as cooling flanges for the capacitor.

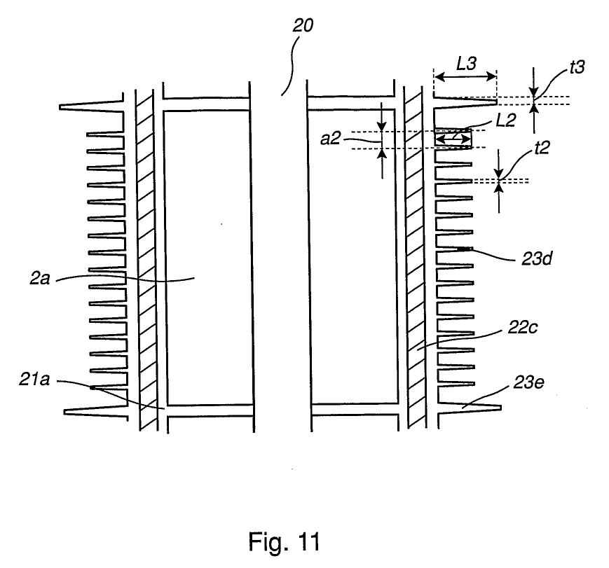

FIG. 11 is a section through a power capacitor according to an additional embodiment. The container 22c consists of a cylindrical polymer tube, for example of polyethylene. On the container, a number of protrusions 23d, 23e are arranged. These are, for example, of silicone rubber or EPDM. A pattern of at least one larger protrusion 23e and a plurality of smaller protrusions 23d is repeated along the whole length of the capacitor. Typical dimensions for a smaller protrusion 23d according to FIG. 11 is a thickness t2 in the interval of 0.2-10 mm, a radial length of L2 in the interval 5-30 mm and an axial pitch a2 of 5-25 mm. Typical dimensions for a larger protrusion 23e according to FIG. 11 is a thickness t3 in the interval of 2-10 mm and a radial length L3 in the interval of 20-60 mm. The protrusions may have a different geometrical appearance from what is shown in FIG. 11, which is controlled by the manufacture and the performance of the power capacitor.

In a power capacitor according to any of FIGS. 7-11, the cylindrical tube 20 is usually mechanically reinforced, for example by armouring; alternatively, a separate tube (not shown) is arranged near the cylindrical tube 20. The cylindrical tube 20 is solid or hollow.

In the manufacture of a power capacitor according to FIGS. 7-11, the manufacture of the protrusions 23, 23a-f is usually performed by injection moulding. Before the injection moulding, the capacitor elements 2a, 2b, 2c are usually arranged on the central tube 20 in a predetermined spaced relationship to one another.

A power capacitor with a container with protrusions manufactured according to any of the preceding methods may be manufactured such that the container blank with protrusions directly corresponds to the size of the power capacitor. The method may also be carried out such that the container blank is made in running length, whereupon suitable lengths adapted to the size of the capacitor are cut therefrom.

To facilitate the adhesion between the protrusions 23b and the container 22b, the container may be coated with silicone before the protrusions are applied.

In the embodiments shown in FIGS. 7-11, the container is provided along all of its length with protrusions. In many cases, it may be sufficient with a few protrusions or one single protrusion to attain the necessary creepage distance. With a suitable design, the protrusions may also have the task of improving the cooling of the capacitor and of functioning as solar protection to reduce the heating of the capacitor in those cases where it is placed so that it is exposed to solar radiation. The colour of the protrusions should suitably be a light one, for example white or grey, to reduce the solar heating of the capacitor.

During manufacture according to the embodiments illustrated in FIGS. 8-11, it is important to achieve good adhesion between the material in the container 22b, for example polyethylene, and the material in the protrusions 23b, for example silicone rubber. To achieve this, the container 22b is allowed, before the application, to undergo a surface modification which may be achieved in a plurality of different ways. One common and known way is to clean the surface with a solvent and then allow the surface to dry. Thereafter, the surface is surface-treated to chemically change the surface properties such that adhesion regions for a subsequent application of a primer are created. The surface treatment may occur by using oxidizing low corona discharges or microwave plasma.

In a final step, a primer is then applied. When the surface has been allowed to dry, the protrusions 23b are injection-moulded on the surface

During manufacture according to the embodiments illustrated in FIGS. 7-11, a diffusion barrier (not shown) of a material suitable for the purpose, for example polyamide, may be applied to at least the inside of the container 22, 22a-d. The diffusion barrier is applied, for example, by extrusion together with the container 22, 22a-d. Where necessary, a diffusion barrier (not shown) is also applied to the tube 20.

The invention is not limited to the embodiments shown; a person skilled in the art may, of course, modify it in a plurality of different ways within the scope of the invention as defined by the claims. Thus, the invention is not limited to the shown arrangement of large and small protrusions but may be varied such that, for example, five small protrusions are surrounded by at least two larger protrusions on each side of the small protrusions.

Further, the invention is not limited to the described embodiments of the container in combination with the described embodiment of the protrusions, but all the embodiments of the container may be combined with any of the described embodiments of the protrusions.

Nor is the invention limited to injection moulding; the container, the protrusions, and the insulation may, for example, be made by casting.

1. A power capacitor, comprising:
at least one capacitor element enclosed in a substantially cylindrical container of a material that substantially comprises a first polymer material, and wherein the container on its envelope surface comprises a plurality of protrusions designed to extend the creepage distance along the container, wherein the protrusions are substantially of a second polymer material, and wherein the protrusions are formed with respect to their thickness and radial length so that they cool the capacitor.

2. The power capacitor according to claim 1, wherein the protrusions comprise at least one protrusion with a thickness in the interval of 0.2-10 mm and a radial length in the interval of 5-50 mm.

3. The power capacitor according to claim 2, wherein the protrusions comprise at least one protrusion with a thickness in the interval of 1-4 mm and a radial length in the interval of 10-25 mm.

4. A The power capacitor according to claim 1, wherein essentially the whole envelope surface of the power capacitor is covered with a plurality of the protrusions.

5. The power capacitor according to claim 1, wherein the protrusions comprise a plurality of smaller protrusions with a thickness in the interval of 0.2-10 mm and a radial length in the interval of 5-30 mm, and wherein the small protrusions are arranged in the vicinity of at least one larger protrusion with a thickness in the interval of 2-10 mm and a radial length in the interval of 20-60 mm.

6. The power capacitor according to claim 5, wherein the protrusions comprise a pattern with a plurality of smaller protrusions and at least one larger protrusion, and wherein the pattern is repeated along essentially the whole envelope surface of the capacitor.

7. The power capacitor according to claim 6, wherein 10-20 smaller protrusions are arranged in the vicinity of at least one larger protrusion.

8. The power capacitor according to claim 1, wherein the protrusions are arranged with an axial pitch in the interval of 5-25 mm.

9. The power capacitor according to claim 1, wherein the capacitor element/s is/are enclosed in at least one insulating medium which is in a state different from a liquid state within the working temperature interval of the capacitor.

10. The power capacitor according to claim 1, wherein the first polymer material and the second polymer material are of the same kind of polymer materials.

11. The power capacitor according to claim 1, wherein the insulating medium, the container and the protrusions of the container are all for the most part of rubber, preferably silicone rubber.

12. The power capacitor according to claim 11, wherein the insulating medium, the container and the protrusions of the container are of the same kind of rubber.

13. The power capacitor according to claim 1, wherein the insulating medium, the container and the protrusions of the container are all for the most part of a thermoset.

14. The power capacitor according to claim 13, wherein the insulating medium, the container and the protrusions of the container are of the same kind of thermoset, and wherein the thermoset is based on one of the following materials: epoxy, polyurethane, polyester.

15. The power capacitor according to claim 1, wherein the insulating medium, the container and the protrusions of the container are injection molded in one single piece.

16. The power capacitor according to claim 1, wherein the container and the protrusions of the container are of different polymer materials.

17. The power capacitor according to claim 16, wherein the container is of polyethylene and the protrusions are of silicone rubber or EPDM.

18. The power capacitor according to claim 16, wherein the container is of fibre-reinforced thermoset and the protrusions are of silicone rubber or EPDM.

19. The power capacitor according to claim 16, wherein the insulating medium is silicone in gel state.

20. The power capacitor according to claim 16, wherein the insulating medium is based on a thermoset.

21. The power capacitor according to claim 1, wherein the capacitor comprises at least one tubular element running in the cylinder direction and extending through each capacitor element.

22. The power capacitor according to claim 21, wherein the tubular element is reinforced by armouring the tubular element.

23. The power capacitor according to claim 1, wherein the container is reinforced by armouring the container.

24. The power capacitor according to claim 1, wherein a diffusion layer is arranged on at least the inside of the container.

25. A method for manufacturing a power capacitor comprising at least one capacitor element enclosed in a substantially cylindrical container made of a material that substantially comprises a first polymer material, and wherein the container on its envelope surface comprises a plurality of protrusions designed so as to extend the creepage distance along the container, the protrusions are made of a second polymer material, that the protrusions are formed with respect to their length and width so that they cool the capacitor, and the capacitor element/s is/are encapsulated in a container.

26. The method according to claim 25, further comprising:
bringing the capacitor element/s to be enclosed in at least one insulating medium which is in state other than liquid state within the working temperature interval of the capacitor.

27. The method according to claim 26, wherein the manufacture of the container, the application of the protrusions, the encapsulation of the capacitor element/s and the enclosure in the insulating medium are achieved by injection molding.

28. The method according to claim 27, wherein the material is rubber, preferably silicone rubber.

29. The method according to claim 27, wherein the injection molding occurs in one single step and with one single material.

30. The method according to claim 27, wherein the injection molding occurs in two steps, whereby in a first step the capacitor element/s is/are enclosed in the insulating medium and in a second step the container is manufactured, and the protrusions are applied, and wherein in the first step a polymer material is used as material which has lower viscosity than the polymer material that is used in the second step.

31. The method according to claim 25, wherein a cylindrical polymer tube is provided for forming the container, wherein the protrusions are applied to the polymer tube, whereby the tube is preferably of polyethylene, and wherein the capacitor element/s is/are placed in the polymer tube.

32. The method according to claim 25, wherein each capacitor element prior to injection molding is applied to a tubular element extending through each capacitor element.

33. The method according to claim 32, wherein the tubular element is reinforced by armouring.

34. The method according to claim 31, wherein the protrusions are applied to the container by injection molding, by winding them in a spiral around the container, or by providing them as prefabricated sleeve-like elements which are threaded onto the container.

35. The method according to claim 25, wherein the container is reinforced by armouring.

36. The method according to claim 25, wherein a diffusion layer is applied to at least the inside of the container.

37. The method according to claim 34, wherein at least the outside of the container is coated with silicone before the protrusions are applied.

38. The method according to claim 31, wherein the protrusions are applied to the container by injection molding and wherein the container is surface-modified prior to the injection molding.

39. The method according to claim 31, wherein a mechanical support is applied for the container prior to the injection molding.

40. Use of a power capacitor according to claim 1 at voltages exceeding 1 kV, preferably at least 5 kV.

41. Use of a power capacitor according to claim 1 in a system for transmission of alternating current (AC).
